(19) United States
(12) Patent Application Publication
(10) Pub. No.: US 2002/0110416 A1
(43) Pub. Date: Aug. 15, 2002

(54) Adjoining device

(75) Inventors: Wing Sum Tang, Hunghom (HK); Yu Ying Tang, Hunghom (HK)

Correspondence Address: MERCHANT & GOULD PC, P.O. BOX 2903, MINNEAPOLIS, MN, 55402-0903, US

(73) Assignee: Samson Bright Industrial Company Limited, Hunghom (HK)

(21) Appl. No.: 10/052,643

(22) Filed: Jan. 18, 2002

(30) Foreign Application Priority Data
Jan. 19, 2001 (DE) 20100994.3

(51) Int. Cl. F16D 1/00

(52) U.S. Cl. 403/408.1

(57) ABSTRACT

The present invention relates to an adjoining device consisting of at least two pieces of elements to be jointed together. The first element having a hole with an adjoining plane at the contact area to the second element, the second element having a flange and a protrusion which fits into the hole of the first element, whereby in the adjoined the flange of the second element is in contact with the adjoining plane of the first element.

### BACKGROUND OF THE INVENTION

There are different methods of adjoining pieces together like screwing, pressing, clamping or wielding. A need exists however for an adjoining device which can be easily fixed and removed without the the need of tools or additional sealing materials. Further the screws or seams of the new adjoining device should not be affected by very fine particles like powdered materials. Additionally it is of great importance for the use in certain appliances of the adjoining devices like a milling or another rotating operation that the parts to be adjoined should be rotatable in the locked position.

### SUMMARY OF THE INVENTION

Therefore it is an object of the present invention to provide an adjoining device for at least two pieces of elements which can be easily secured in the adjoined position and which can be removed without the use of tools or thermal energy.

It is a further object of the present invention to provide an adjoining device which can be turned around and rotated so that there can be a milling operation or any other revolving motion.

This object is achieved by an adjoining device characterized in that the adjoining device consists of at least two pieces of elements to be jointed together, the first element having a hole with an adjoining plane at the contact area to the second element the second element having a flange and a protrusion which fits into the hole of the first element, whereby the flange of the second element is in contact with the adjoining plane of the first element in the adjoined position.

The new device can be preferably used for hand milling operations or any other hand agitated motion wherein two compartments are pivotated on the same rotary axis and can be easily fixed by inserting the two elements with a low pressure movement in only one direction without the use of tools or any other auxiliary means.

### BRIEF DESCRIPTION OF THE DRAWINGS

A more complete understanding of the present invention may be had by reference to the following detailed description of the invention when considered in conjunction with the accompanying drawings wherein:

FIG. 1 is a cross-sectional view of an adjoining device according to the present invention consisting of two elements just before the adjoined position.

FIG. 2 is a side view of the second element 2.

FIG. 3 is a front view of the second element 2.

### DETAILED DESCRIPTION OF THE PREFERRED EMBODIMENTS

The present invention relates to an adjoining device consisting of at least two pieces of elements to be jointed together. The first element having a hole with an adjoining plane at the contact area to the second element, the second element having a flange and a protrusion which fits into the hole of the first element, whereby in the adjoined the flange of the second element is in contact with the adjoining plane of the first element.

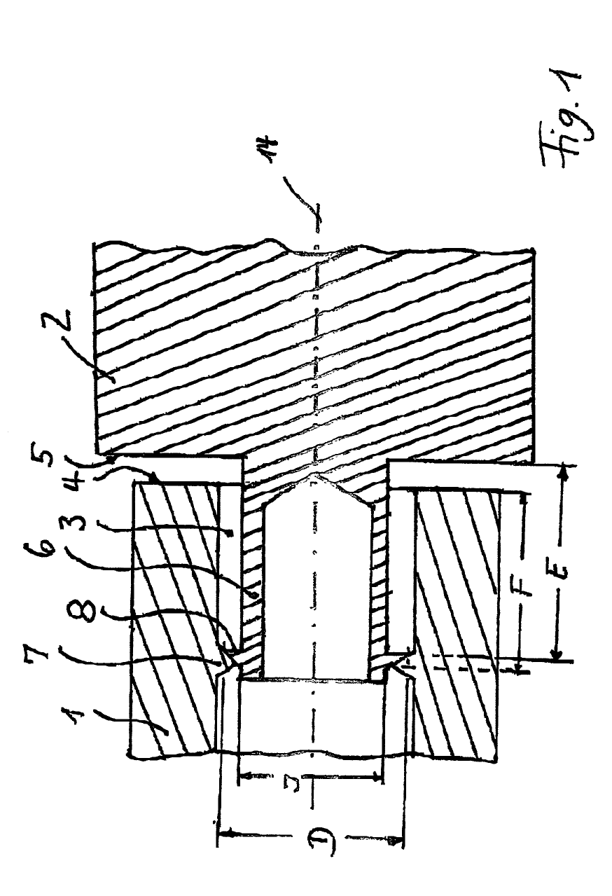

In FIG. 1 two pieces of elements 1, 2 are shown in the position just before reaching the secured position.

Inside a hole 3 of the first element 1 a circular rim 7 is positioned at the circumference of the hole. The circular rim 7 has an inside diameter I and a cross-section of a triangle with a slanting angle α.

At the contact area to the second element 2 the first element has an adjoining plane 4 which represents the front side. On the adjoining plane 4 the flange 5 of the second element 2 can slide like a friction bearing.

The second element 2 has a flange at the contact area and a protrusion 6 which fits into the hole 3 of the first element 1. At the head of the protrusion 6 of the second element 2 a circular ring 9 with a triangular cross-section is formed. Of cause the circular ring 8 can be a separate ring which is permanently fixed to the surface of the protrusion 6.

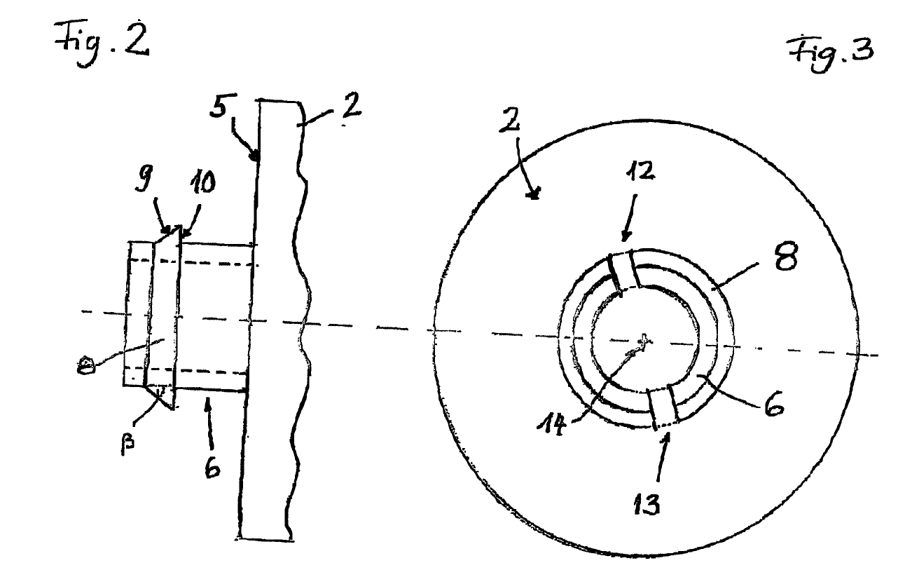

The diameter D of the circular ring 8 measured at the top of the triangular cross-section is greater than the inside diameter I of the rim 7. Therefore in order to receive the adjoined position the circular ring 8 of the second element 2 should pass the rim 7 of the first element 1. For this motion the circular ring 8 has a slanting plane 9 which slants into the direction of the protrusion's head and the rim 7 has a slanting angle α which is preferably similar or equal to the slanting angle β of the ring 8 (see FIG. 2).

The backside 10 of the ring 8 brakes down from the top of the ring so that it reaches the surface 11 of the protrusion 6 at an angle of about 90°. Therefore in the locked position the elements 1, 2 can not be removed or displaced from each other because the backside 10 of the rim 8 abuts the rim 7.

In the secured position the adjoining plane 4 is in contact with the flange 5 and the rim 7 lies behind the backside 10 of the ring 8. Therefore the distance D measured from the flange 5 to the backside 10 of the ring 8 should be greater than the distance F measured from the adjoining plane 4 until the top of the rim 7.

In FIG. 2 the second element 2 is shown in an enlarged side view. At the front or head of the protrusion 6 the ring 8 is formed with a slanting plane 9 and a backside 10 breaking down from the top of the ring so that it reaches the surface 11 of the protrusion 6 at an angle of 90°. Between the slanting plane 9 and the surface of the protrusion 6 an angle β=30-60° can be used to force of fixing both elements 1, 2 in the adjoined position. On the opposite the backside 10 has an angle of about 90° in order to secure both elements 1, 2 in the adjoined position. The locking mechanism is at the head of the cylindrical protrusion. Because the head has circular cross-section with a circumference which is slightly smaller than the circumference of the cross-section of the adjoining cylinder the head can be inserted into the hole of the adjoining cylinder.

As can be seen in FIG. 3 (front view) the protrusion 6 and the ring 8 have slots 12, 13 which are symmetrically positioned relative to the cylinder axis 14. The slots 12, 13 are radial openings which weaken the stiffness of the protrusion 6 and the ring 8. Therefore the number of slots or radial openings will determine the force which is necessary to adjoin the elements 1, 2 in order to reach or receive the secured position.

The adjoining device should preferably be circular in cross-section and the protrusion can be a hollow cylinder which fits the hole at the receiving end of the first element 1. The extend of the cylindrically protrusion of the second element 2 is optional depending on how deeply the locking mechanism should be fitted into the hole of the first element.

In a preferred embodiment the head of ring 8 extends downwards at a slanting angle so that the end of the head fits on top of the protruding cylinder. The circumference of the end of the base is slightly larger than the circumference of the cross-section of the adjoining cylinder so that it forms a slightly protruding ring around the base of the head.

The receiving end has a circular hole with a circumference which fits the cylindrical protrusion of the second element. The location of the rim is dependant on where the locking should occurs. The rim is designed to lock the protruding ring in a pivotable position. Once the ring has passed through the rim the backside of the ring is in contact with the back of the rim. Since the circumference of the ring is larger than the circumference of the rim the ring can only pass the rim on the following conditions:

First of all the slanting edge of the head of the protrusion guides the head to a certain position where the circumference of the ring and the area of the rim are in contact. In the area of contact the slanting angles of the rim and the ring have about the same value.

Secondly there are at least two openings in the cylindrical protrusions which are perpendicular and which truncated the cylinder. These openings or slots allow the cylinder to fold slightly inwards guided by the slanting edge of the head of the protrusion where a strong force is applied to push the cylinder into the receiving end.

Once the cylinder has passed through the rim the cylinder will be released to its original shape and the protruding ring will take a locked position at the backside of the rim. In this locked position the two ends cannot be separated except by breaking the rim or the device altogether. It follows that the adjoining device according to the present invention provides a securely locking mechanism for adjoining at least two pieces of elements.

1. Adjoining device consisting of at least two pieces of elements (1, 2) to be jointed together, the first element (1) having a hole (3) with an adjoining plane (4) at the contact area to the second element (2),
the second element (2) having a flange (5) at the contact area and a protrusion which fits into the hole (3) of the first element, whereby in the adjoined position the flange (5) of the second element is in contact with the adjoining plane (4) of the first element,
characterized in, that
inside the hole (3) of the first element in a distance F from the adjoining plane (4) a circular rim (7) is positioned at the circumference of the hole,
at the head of the protrusion (6) of the second element a circular ring (8) with triangular cross-section is formed in a distance E from the flange (5),
the diameter D of the circular ring (8) measured at the top of the triangular cross-section is greater then the inside diameter I of the rim (7),
the circular ring (8) with an slanting plane (9) slants into the direction of the protrusion's head and a backside (10) breaking down from the top of the ring (8) so that it reaches the surface (11) of the protrusion (6) at an angle of about 90°,
and that the head of the protrusion (6) of the second element is deformed elastically when passing the rim (7) of the first element to recover the adjoined position.

2. Adjoining device according to claim 1,
wherein the protrusion (6) is made of a hollow cylinder or a tube having at least two slots (12, 13) positioned symmetrically to the cylinder axis (14) at the periphery of the protrusion (6).

3. Adjoining device according to one of the above-mentioned claims,
characterized in
that the slots (12, 13) consist of a series of radial openings which weaken the stiffness at the front side of the protrusion (6).

4. Adjoining device according to one of the above-mentioned claims,
characterized in
that the frontside of the rim (7) if viewed form the adjoining plane (4) has the form of a slanting plane with a slanting angle α.

5. Adjoining device according to one of the above-mentioned claims,
characterized in
that the slanting angle α of the rim (7) has the same value as the slanting angle β of the circular ring (8).

6. Adjoining device according to one of the above-mentioned claims,
characterized in
that the slots (12, 13) allow the protrusion's head to fold inwards guided by the slanting plane of the rim (7) and the ring (8).
